(19) United States
(12) Patent Application Publication
(10) Pub. No.: US 2018/0020800 A1
(43) Pub. Date: Jan. 25, 2018

(54) Hair Care Tool and Related Methods

(71) Applicant: NanaComb Vision, LLC, Florissant, MO (US)

(72) Inventor: Madeline Jackson, Florissant, MO (US)

(21) Appl. No.: 15/650,190

(22) Filed: Jul. 14, 2017

Related U.S. Application Data
(60) Provisional application No. 62/364,194, filed on Jul. 19, 2016.

(51) Int. Cl. A45D 24/02; A45D 24/22

(52) U.S. Cl. CPC A45D 24/02; A45D 24/22; A61H 2205/021

(57) ABSTRACT

In an exemplary embodiment, a tool for hair care generally includes a handle, a supporting structure extending distally from the handle, and a plurality of curved teeth having curved cross sections. Each tooth terminates in a rounded tip. A lateral one of the teeth extends generally distally from a lateral portion of the supporting structure. At least some others of the teeth extend generally distally from a distal portion of the supporting structure. Tool embodiments can alleviate hair care and styling problems encountered by users who have curly, coarse, and/or coiled hair.

### CROSS-REFERENCE TO RELATED APPLICATION

This application claims the benefit of U.S. Provisional Application No. 62/364,194, filed on Jul. 19, 2016. The entire disclosure of the above application is incorporated herein by reference.

### FIELD

The present disclosure generally relates to hair care, and more particularly (but not exclusively) to a hair care tool and related methods.

### BACKGROUND

This section provides background information related to the present disclosure which is not necessarily prior art.

Hair care is an essential element of personal grooming performed by millions of people every day. Hair combs have been used since ancient times to groom and style hair. A typical comb has an elongate base and a row of straight teeth extending from the base.

### SUMMARY

This section provides a general summary of the disclosure, and is not a comprehensive disclosure of its full scope or all of its features.

According to various aspects, exemplary embodiments are disclosed of a tool for hair care. In an exemplary embodiment, a tool for hair care generally includes a handle, a supporting structure extending distally from the handle, and a plurality of curved teeth having curved cross sections. Each tooth terminates in a rounded tip. A lateral one of the teeth extends generally distally from a lateral portion of the supporting structure. At least some others of the teeth extend generally distally from a distal portion of the supporting structure.

In another example embodiment, the disclosure is directed to a tool for hair care that generally includes a handle, a rigid, curved supporting structure extending distally from the handle, and a plurality of curved teeth extending generally distally from the supporting structure. A lateral one of the teeth extends from a lateral portion of the supporting structure, and distal ones of the teeth extend from a distal portion of the supporting structure. The lateral tooth is shorter than the distal teeth. Each tooth has a rounded tip and a taper terminating in the rounded tip.

Also disclosed are methods that generally include a method of making a hair care tool. One example method includes placing a material into a mold to form a supporting structure and a plurality of curved teeth extending generally distally from the supporting structure, each tooth terminating in a rounded tip, one of the teeth extending from a lateral portion of the supporting structure. The method further includes removing the molded material from the mold.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top view of a hair care tool according to exemplary embodiments;

FIG. 2 is a top perspective view of the hair care tool of FIG. 1;

FIG. 3 is a side view of the hair care tool of FIG. 1;

FIG. 4 is a frontal view of the hair care tool of FIG. 1;

FIG. 5A is a top view of a hair care tool according to exemplary embodiments;

FIG. 5B is a top perspective view of the hair care tool of FIG. 5A;

FIG. 5C is a side view of the hair care tool of FIG. 5A;

FIG. 5D is a frontal view of the hair care tool of FIG. 5A;

FIG. 5E is a rear view of the hair care tool of FIG. 5A;

FIG. 5F is a bottom view of the hair care tool of FIG. 5A;

FIG. 6A is a top perspective view of a hair care tool according to exemplary embodiments;

FIG. 6B is a front perspective view of the hair care tool of FIG. 6A;

FIG. 6C is a bottom view of the hair care tool of FIG. 6A; and

FIG. 6D is a top view of the hair care tool of FIG. 6A.

Corresponding reference numerals indicate corresponding parts throughout the several views of the drawings.

### DETAILED DESCRIPTION

Example embodiments will now be described more fully with reference to the accompanying drawings.

The inventor hereof has recognized that how people care for their hair can be a complex subject and often is based on ethnicity, culture and economics. The inventor also has recognized that a contradiction exists in the world of hair care. Although the majority of the world's population is composed of curly haired individuals, existing hair care tools and products typically are made for persons with straight or only slightly wavy hair. One of the main complaints for persons with thick, naturally curled/coiled hair is that their hair tools break or shred their hair, preventing hair growth.

Accordingly, the inventor has developed and discloses herein exemplary embodiments of a hair care tool and related methods. In one example embodiment, a tool for hair care includes a handle and a supporting structure extending distally from the handle. The tool also includes a plurality of curved teeth having curved cross sections. Each tooth terminates in a rounded tip. At least one of the teeth extends generally distally from a lateral portion of the supporting structure. Others of the teeth extend generally distally from a distal portion of the supporting structure.

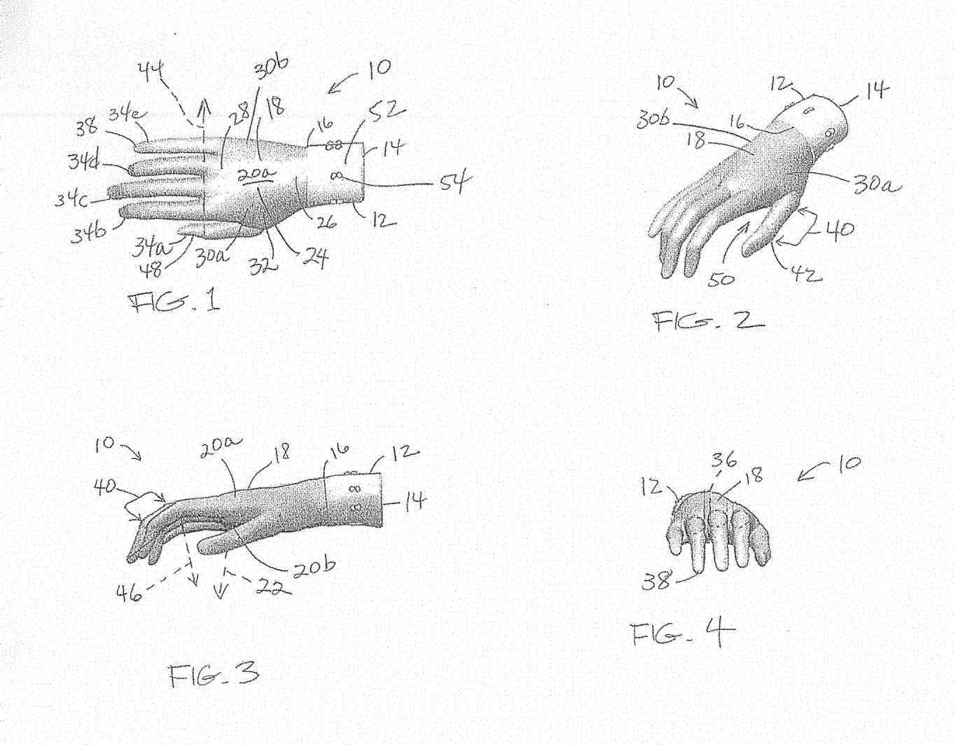

With reference now to the figures, FIGS. 1 through 4 illustrate an exemplary embodiment of a hair care tool embodying one or more aspects of the present disclosure. A hair care tool 10 includes a handle or base 12 having a proximal end 14 and a distal end 16. A slightly arched supporting structure 18 extends distally from the distal end 16 of the handle 12. As shown in FIG. 3, an upper surface 20a and a lower surface 20b of the supporting structure 18 have curvatures generally centered below the lower surface 20b, as indicated by an arrow 22. The supporting structure 18 includes a central portion 24, a proximal portion 26, a distal portion 28, and lateral portions 30a and 30b. The portions 24, 26, 28 and 30(a, b) are integral with one another so as to provide a smooth, continuous surface for the supporting structure 18. As shown in FIG. 1, a gradually widening prominence 32 of the lateral portion 30a contributes to a progressive widening of the supporting structure 18 from its proximal portion 26 to its distal portion 28.

The supporting structure 18 supports a plurality of curved teeth 34a-34e, collectively referred to by reference number 34. In the present example embodiment, the teeth 34 are rigid and, as shown by dashed lines in FIG. 4, have generally circular cross sections 36. Each tooth 34 is generally tapered and terminates in a rounded tip 38. In the present example embodiment, each tooth 34 has a plurality of segments 40 joined end-to-end, e.g., at non-straight angle(s) 42 to provide curvature to the tooth. In various embodiments, the curvature of a given tooth could be provided through fewer non-straight angles, additional non-straight angles, or could be provided as a continuous curvature, etc. In the present example embodiment, the teeth 34 have smooth, generally continuous surfaces that are integral with the generally continuous and smooth surfaces of the supporting structure 18.

In the present example embodiment, five teeth 34 are provided, although in other embodiments, more than or fewer than five teeth could be provided. In the present example embodiment, the teeth 34 vary in length and curvature, the central tooth 34c being slightly longer than the other teeth 34. The tooth 34a (hereinafter referred to as a “lateral” tooth) extends generally distally from the lateral portion 30a of the supporting structure 18. The teeth 34(b-e) (hereinafter referred to as “distal” teeth) extend generally distally from the distal portion 28 of the supporting structure 18. As indicated by an arrow 44 in FIG. 1, the example lateral tooth 34a has curvature centered generally in the direction of the distal teeth 34(b-e). As indicated by an arrow 46 in FIG. 3, the example distal teeth 34(b-e) have curvature centered generally below the lower surface 20b of the supporting structure 18.

In various embodiments, various segments of a tooth may be straight and/or exhibit curvature in directions other than a general direction of curvature of the tooth as a whole. For example, as shown in FIG. 1, the lateral tooth 34a of the tool 10 includes an end segment 48 having a curvature in a direction generally opposite that of the arrow 44. Hair care tool embodiments may be provided in which various degree(s) of tooth tapering and/or curvature are provided, as may be desired by various users. Additionally or alternatively, various angles may be provided between teeth in various embodiments. For example, as shown in FIGS. 2 and 3, the lateral tooth 34a of the tool 10 extends slightly downward compared to the digital teeth 34(b-e), thereby forming an angle 50, e.g., of about 30 degrees, between the lateral tooth 34a and the digital tooth 34b. Other or additional degrees of angular separation could be provided between various teeth in various embodiments.

In the present example embodiment, the tool 10 is rigid and lightweight, e.g., less than about four ounces, although heavier embodiments also are contemplated. The example tool 10 is about 6.25 inches in total length, between the proximal end 14 of the handle 12 and the rounded tip 38 of the digital tooth 34c. The example tool 10 has a maximum width of about 2.49 inches. The lateral tooth 34a has a length of about 2.09 inches, and the distal tooth 34c has a length of about 2.37 inches. The teeth 34a and 34b are separated by about 0.75 inches measured at the tip 58 of the lateral tooth 43a. As measured at the supporting structure 18, distances between the teeth 34 are approximately as follows:

0.12 inches between teeth 34a and 34b

0.15 inches between teeth 34b and 34c

0.13 inches between teeth 34c and 34d

0.14 inches between teeth 34d and 34e

The maximum widths of the teeth 34 are approximately as follows:

lateral tooth 34a: 0.40 inches

distal tooth 34b: 0.44 inches

distal tooth 34c: 0.43 inches

distal tooth 34d: 0.41 inches

distal tooth 34e: 0.36 inches

The curvatures, dimensions, relative spacing and continuously smooth surfaces of the teeth 34 and supporting structure 18 are configured to cooperatively facilitate the smooth entry of the teeth 34 into a user's hair and also to cooperatively facilitate the smooth passage of the teeth 34 and, in some embodiments, the supporting structure 18, through the user's hair without scratching the scalp or pulling the hair. A user may devise personal hair care techniques for employing one or more teeth of a hair care tool embodiment, to achieve a particular effect. For example, in embodiments in which a central tooth (such as the tooth 34c) is slightly longer than other teeth, the central tooth may be inserted and moved through the hair before the other teeth become engaged in the hair, thereby slightly parting the hair to make the way easier for entry and movement of other teeth into and through the hair. As another example, tips 38 of the distal teeth 34b-34e are farther away from the supporting structure 18 than is the tip 38 of the lateral tooth 34a. As the user moves the tool 10 through the hair, the user may angle the tool 10 relative to the user's scalp such that the lateral tooth 34a is the only tooth 34 moving through the hair. In such manner, the lateral tooth 34a may be used to lift hair and gently push it in the direction of movement of the tool 10. Such use of the lateral tooth 34a may facilitate the user's movement of other teeth 34 through the user's hair during subsequent combing.

The handle 12 has a generally cylindrical shape, although in other embodiments a handle can have other or additional shapes. The example handle 12 includes a textured surface portion 52, e.g., a plurality of regularly spaced nodules 54, to provide a user with a secure grip. Other handle embodiments can have other or additional textured surfaces, including but not limited to surfaces having other or additional types of protrusions, ridges, indentations, grooves, etc. Such surfaces may be produced integrally with the handle, applied externally to a previously fabricated handle, etc.

The example handle 12 is about 1.28 inches long and about 1.33 inches wide. In various embodiments, hair care tools and their various structures may have various sizes, lengths, widths, weights, relative spacing, numbers and arrangements of teeth, etc. For example, hair care tool embodiments may vary in size, e.g., from smaller “mini” tools to larger tools, e.g., to accommodate various hair lengths and/or textures. Additionally or alternatively, embodiments may be provided that, e.g., are mirror images, e.g., of other embodiments, e.g., to accommodate left and/or right-handed users. In some embodiments, a symmetrical arrangement of teeth may be provided, e.g., to accommodate both left- and right-handed users. In various embodiments, a handle may be at least partially flat, elongated, shaped, etc. to provide various grip and projection characteristics.

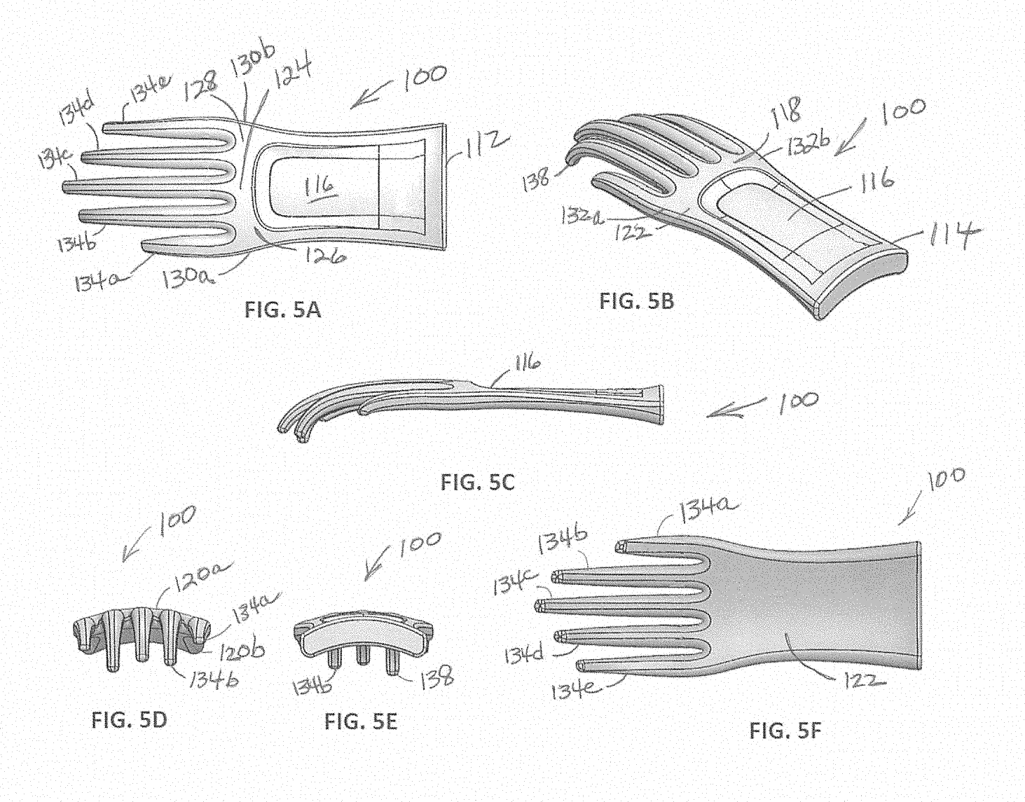

Another example embodiment of a hair care tool is indicated generally in FIGS. 5A through 5F by reference number 100. The hair care tool 100 includes a handle or base 112 having a proximal end 114. The handle 112 also has a hollow area 116 shaped to facilitate user handling of the tool 100. A slightly arched supporting structure 118 extends distally from the handle 112, which in the present example embodiment is also slightly arched. As shown in FIG. 5D, an upper surface 120a and a lower surface 120b of the supporting structure 118 have curvatures generally centered below the lower surface 120b. The supporting structure 118 includes a central portion 124, a proximal portion 126, a distal portion 128, and lateral portions 130a and 130b. The handle 112 and supporting structure 118 are integral with each another. As shown in FIGS. 5B and 5F, a generally smooth, continuous surface 122 of the handle 112 extends into the supporting structure 118. Widening prominences 132a and 132b of the lateral portions 130a and 130b contribute to a progressive widening of the supporting structure 118.

The supporting structure 118 supports a plurality of curved teeth 134a-134e, collectively referred to by reference number 134. In the present example embodiment, the teeth 134 are rigid and have curved cross sections. As can be seen in FIG. 5C, portions of the teeth 134 that are proximal to the supporting structure 118 are generally parallel with one another, but curvatures of the teeth 134 increasingly vary relative to one another as the teeth 134 extend distally away from the supporting structure 118. Each tooth 134 is generally tapered and terminates in a rounded tip 138. In the present example embodiment, surfaces of the teeth 134 are smooth, hard, and integral with surfaces of the supporting structure 118. Embodiments are possible, however, in which protuberances, ridges, edges, depressions, pores, holes, and/or other types of surface interruptions may be provided in relation to teeth and/or supporting structures.

In the present example embodiment, five teeth 134 are provided, although in other embodiments, more than or fewer than five teeth could be provided. In the present example embodiment, the teeth 134 vary in length and curvature. The teeth 134a and 134e (hereinafter referred to as “lateral” teeth) extend generally distally, respectively from the lateral portions 130a and 130b of the supporting structure 118. The teeth 134(b-d) (hereinafter referred to as “distal” teeth) extend generally distally from the distal portion 128 of the supporting structure 118. In the present example embodiment, the lateral tooth 134e is shorter than the distal teeth 134(b-d) and is longer than the lateral tooth 134a. The teeth 134 have curvatures centered generally below the lower surface 120b of the supporting structure 118.

The example tool 100 is about 7.7 inches in total length, as measured in a straight line from the proximal end 114 of the handle 112 to above the rounded tip 138 of the digital tooth 134c. The example tool 100 has a maximum width of about 2.8 inches. As measured near the supporting structure 118, distances between adjacent teeth 134 are approximately 0.15 inches. Distances between the tooth tips 138 are wider, due to the tapering of the teeth 134.

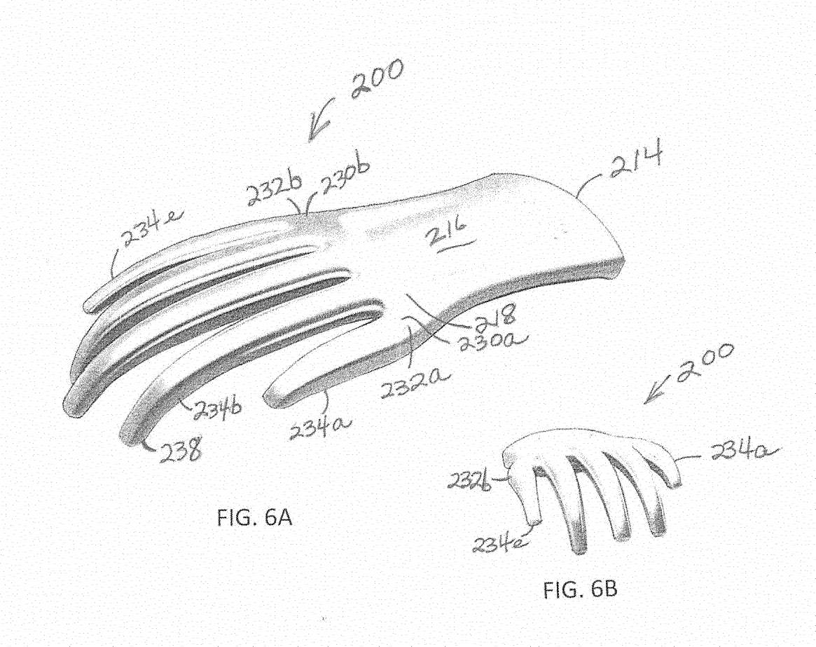

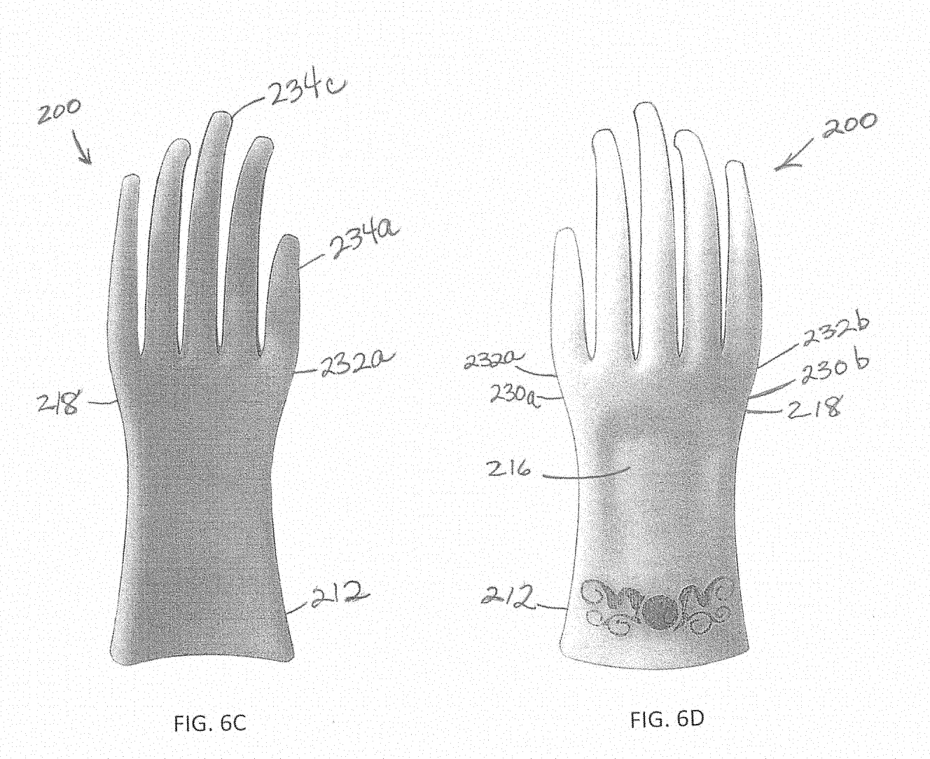

Another example embodiment of a hair care tool is indicated generally in FIGS. 6A through 6D by reference number 200. The tool 200 is molded as a single, smooth-surfaced piece that includes a handle or base 212 having a proximal end 214. The handle 212 has a hollow area 216 extending into a supporting structure 218 and shaped to facilitate user handling of the tool 200. The supporting structure 218 extends distally from the handle 212. Widening prominences 232a and 232b of supporting structure lateral portions 230a and 230b contribute to a progressive widening of the supporting structure 218.

The supporting structure 218 supports a plurality of curved teeth 234a-234e, collectively referred to by reference number 234. In the present example embodiment, the teeth 234 are rigid, have curved cross sections, and are generally parallel with one another close to the supporting structure 218. Farther away from the supporting structure 218, the teeth exhibit individual curvatures as they taper toward and terminate in rounded tips 238.

In various embodiments, a hair care tool may be configured so as to allow a user to stand the tool upright on its proximal end, e.g., on a countertop or shelf. Embodiments also are possible in which teeth and a supporting structure are fabricated separately from a handle, which may be provided as a separate component. The distal end of such a handle may be glued, pinned, fused, bolted or otherwise affixed to the proximal end of the supporting structure. In some embodiments, a handle may be reversibly connectible with the proximal end of a supporting structure. For example, a handle and/or a supporting structure may include, e.g., one or more screws, screwing surfaces, channels, slots, tabs, sleeves, etc. whereby the handle is reversibly connectible with the supporting structure. In one example embodiment, two or more handles having, e.g., different lengths and/or shapes may be used interchangeably as to a given hair care tool, e.g., for styling hair of different lengths, accommodating different user hand sizes and/or grip preferences, etc.

In various embodiments, a hair care tool may be manipulated relative to hair in various ways to achieve various effects. For example, one or more teeth of a hair care tool may be inserted into hair, and the hair care tool may be pushed, pulled, and/or twisted, e.g., at various angles, relative to a user's hair to obtain various care and/or styling effects. In various embodiments, a hair care tool may be configured to hold one or more hair care substances and/or may be embedded with one or more hair care substances for release thereof during usage of the hair care tool. In some example embodiments, one or more teeth and/or other component(s) of a hair care tool may be, e.g., infused with, at least partially filled with, encapsulated with, coated with, etc., a hair care substance, e.g., aloe, coconut oil, jojoba oil, vitamin E, and/or other substance(s). In some example embodiments, a hair care tool may be configured to allow controlled and gradual release of such substance(s) in small amounts, over time, during normal and multiple usages of the hair care tool.

In various embodiments, a hair care tool may be configured to vibrate, e.g., to provide a massage and/or scalp stimulation. In some embodiments, and referring to the example embodiment shown in FIGS. 1-4, one or more of the teeth 34 of the hair care tool 10 may have at least some degree of external softness and/or pliability, e.g., at the tips 38. Such teeth 34 may, e.g., have a rigid internal structure operable, e.g., by a battery provided in/on the hair care tool 10. In some embodiments, the hair care tool 10 may be operable, e.g., to provide a gentle vibration/pulse/massage to a user's head and scalp area.

In various embodiments, the temperature of a hair care tool may be changed, e.g., to provide warmth or coolness to a user's hair and/or scalp. In some embodiments, a warming or cooling device or substance may be provided, e.g., embedded, in a hair care tool to produce a warming or cooling sensation to a user's head and/or scalp area. In some example embodiments, substances including but not limited to oils may be supplied and/or provided in and/or on a hair care tool and may be warmed to provide a warm oil treatment for hair and/or scalp. Other or additional materials, pads, compositions, etc. could be provided for a hair care tool to accentuate the touch and feel of oils and/or other substances against a user's hair and/or scalp.

In one example method, a hair care tool may be made as follows. Material, which could include, e.g., silicon, resin, plastic, metal, etc., is placed into a mold. Acrylonitrile butadiene styrene (ABS) plastic material, for example, may provide strength and rigidity so as to be an appropriate material from which to make various hair care tool embodiments. In some embodiments, polypropylene plastic may be used. The mold is configured to form a supporting structure and a plurality of curved teeth extending generally distally from the supporting structure. The mold provides the teeth with shaping such the each tooth would terminate in a rounded tip. One tooth would extend from a lateral portion of the supporting structure, and others of the teeth would extend from a distal portion of the supporting structure. When the molding process is completed, the molded material is removed from the mold. In various embodiments, the mold is configured also to form a handle of the tool. Alternatively, a separately fabricated handle may be affixed to the molded material.

In various embodiments, the foregoing hair care tool is lightweight for ease of usage and of a seamless, smooth design. Various sizes, colors, and designs are possible so as to appeal to various users. In various embodiments of the disclosure, a hair styling apparatus can be provided to de-tangle, groom, and/or distribute product in curly, coarse, or coiled hair, effectively reducing resistance, present with other products, that unduly causes stress and splits to fragile hair shafts and strands. Traditional styling tools (including combs, brushes, and picks) are typically ineffective to properly groom thick and curly hair. They often cause breakage and pain to people attempting to style their hair, and often fail to promote healthy hair and scalps. Embodiments of the foregoing styling tool differ from what currently exists for the curly, coarse, or coiled hair demographic. The tool is designed to gently catch and release curls, allowing them to fall in a tangled free natural pattern. Various embodiments of the disclosure address the flaws in traditional hair tools and combing methods and provide a natural alternative to removing tangles and distributing product.

Embodiments of the foregoing hair care tool can fill a need of users who have thick curly hair and who desire a healthier, well groomed, radiant head of hair. Traditional hair combs are largely ineffective for persons with thick or tightly curled hair. Such combs tend to become caught and tangled and tend to break the curly hair strands. Sometimes the thickness of the hair tends to break the traditional comb itself.

Various hair picks and rakes used today do not provide the functionality to allow tightly curly hair to retain its normal and natural shape and spring. Instead the hair tends to separate and cause individual strands to compact on themselves, creating less of a curled style than a packed, more tangled, less attractive result. Styling products generally do not get evenly distributed through the hair; the individual clusters of curls are not distinguishable; the hair appears dry, molded and lifeless. The inventor has noted that naturally tightly curled hair grows in an ‘s’ or ‘z’ pattern from the scalp. The hair follicle itself tends to be asymmetrical and has fewer cuticles than straight or mildly curly hair. Most curly hair has lower moisture composition than other types of hair, causing it to be dryer, brittle and much more susceptible for breakage. Human scalps naturally produce oils and moisture called sebum. In curly hair, however, the distribution of these natural oils is lessened by the shape of the hair shaft, which further limits the hair's strength and flexibility.

Various embodiments can provide a hair styling tool that does not stress or pull at the distinctive structure of the thickly curled/coiled hair shaft of the majority of the world's population. Such a tool can be used to gently grab and release curls, which can facilitate the distribution of hair care product throughout the entire hair strand. Embodiments of the foregoing unique styling tool and methods can bridge the gap between the combs, brushes and styling products of prior art, to meet the hair care demands and challenges of men, women, and children with thick curly hair.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tool for hair care, the tool comprising:
a handle;
a supporting structure extending distally from the handle; and
a plurality of curved teeth having curved cross sections, each tooth terminating in a rounded tip;
a lateral one of the teeth extending generally distally from a lateral portion of the supporting structure; and
at least some others of the teeth extending generally distally from a distal portion of the supporting structure.

2. The tool of claim 1, wherein each tooth has a taper terminating in the rounded tip of the tooth.

3. The tool of claim 1, wherein the plurality of teeth vary in length and/or in curvature.

4. The tool of claim 1, wherein the teeth comprise a second lateral tooth longer than the lateral one of the teeth, the second lateral tooth extending generally distally from a second lateral portion of the supporting structure.

5. The tool of claim 1, wherein the plurality of teeth comprises five teeth.

6. The tool of claim 1, wherein the handle comprises one or more of the following: a generally cylindrical shape, a generally flat shape, a generally curved shape, a hollow area, and a textured surface portion.

7. The tool of claim 1, wherein:
each tooth has a plurality of segments joined end-to-end, whereby the tooth is curved; and/or
the tooth extending generally distally from the lateral portion of the supporting structure has a curvature centered generally in the direction of the other teeth.

8. A tool for hair care, the tool comprising:
a handle;
a rigid, curved supporting structure extending distally from the handle; and
a plurality of curved teeth extending generally distally from the supporting structure;
a lateral one of the teeth extending from a lateral portion of the supporting structure, and distal ones of the teeth extending from a distal portion of the supporting structure, the lateral one of the teeth being shorter than the distal teeth;
each tooth having a rounded tip and a taper terminating in the rounded tip.

9. The tool of claim 8, comprising one or more of the following materials: silicon, resin, plastic, and metal.

10. The tool of claim 8, comprising a length of between 5 and 8 inches between a proximal end of the handle and the rounded tip of a longest one of the teeth.

11. The tool of claim 8, wherein the plurality of teeth comprise five teeth.

12. The tool of claim 8, wherein the plurality of teeth comprise various lengths and/or curvatures.

13. The tool of claim 12, wherein a central one of the teeth is longer than the other teeth.

14. The tool of claim 8, wherein the teeth comprise a second lateral tooth extending generally distally from a second lateral portion of the supporting structure.

15. The tool of claim 14, wherein the second lateral tooth is shorter than the teeth extending from the distal portion.

16. A method of making a tool for hair care, the method comprising:
placing a material into a mold to form a supporting structure and a plurality of curved teeth extending generally distally from the supporting structure, each tooth terminating in a rounded tip, one of the teeth extending from a lateral portion of the supporting structure; and
removing the molded material from the mold.

17. The method of claim 16, further comprising placing the material into the mold to form a handle.

18. The method of claim 16, further comprising connecting the molded material with a handle and/or providing interchangeable handles.

19. The method of claim 16, wherein the material includes one or more of the following: silicon, resin, plastic, and metal.

20. The method of claim 16, further comprising configuring the tool to perform one or more of the following: apply a hair care substance, vibrate, apply heat, and provide cooling.
